(19) United States
(12) Patent Application Publication
(10) Pub. No.: US 2018/0073514 A1
(43) Pub. Date: Mar. 15, 2018

(54) STOPPING ROTATION OF FAILED FANS

(71) Applicant: HEWLETT PACKARD ENTERPRISE DEVELOPMENT LP, Houston, TX (US)

(72) Inventors: Kai Zhang, Houston, TX (US); Rachel Pollock, Houston, TX (US); Sze Hau Loh, Houston, TX (US)

(21) Appl. No.: 15/264,889

(22) Filed: Sep. 14, 2016

(51) Int. Cl. F04D 27/00; F04D 25/16; F04D 25/08; F04D 29/32

(52) U.S. Cl. CPC F04D 27/008; F04D 25/166; F05B 2240/20; F04D 29/329; F04D 25/08

(57) ABSTRACT

In various examples, a device comprises a fan. The fan comprises a rotor hub, and a linear solenoid. The linear solenoid comprises a magnetic coil, a pin, and a spring surrounding the pin to bias the pin. Responsive to the fan losing power, the solenoid to: cause the pin to contact the rotor hub to cause the rotor hub to stop spinning.

### BACKGROUND

A fan may comprise a rotor. The rotor may spin, thereby causing to cause blades of the fan to spin, and to generate airflow.

### BRIEF DESCRIPTION OF THE DRAWINGS

Certain examples are described in the following detailed description and in reference to the drawings, in which:

FIG. 1 is a conceptual diagram of example of a fan that may limit reverse airflow in the event of the fan losing power;

FIG. 2 is another conceptual diagram of an example of a fan that may limit reverse airflow in the event of the fan losing power;

FIG. 3 is another conceptual diagram of an example of a fan that may limit reverse airflow in the event of the fan losing power;

FIG. 4 is a conceptual diagram of example of a fan that may limit reverse airflow in the event of the fan losing power;

FIG. 5 is a conceptual diagram of an example of a fan that may limit reverse airflow in the event of the fan losing power;

FIG. 6 is a conceptual diagram of example of a fan that may limit reverse airflow in the event of the fan losing power;

FIG. 7 illustrates another example of a fan that may limit reverse airflow in the event of the fan losing power;

FIG. 8 illustrates another example of a fan that may limit reverse airflow in the event of the fan losing power;

FIG. 9 illustrates another example of a fan that may limit reverse airflow in the event of the fan losing power;

FIG. 10 illustrates another example of a fan that may limit reverse airflow in the event of the fan losing power;

FIG. 11 illustrates another example of a fan that may limit reverse airflow in the event of the fan losing power;

FIG. 12 is a flowchart illustrating an example method that may limit reverse airflow in the event of the fan losing power; and

FIG. 14 is a flowchart illustrating another example method that may limit reverse airflow in the event of the fan losing power; and

FIG. 14 is a flowchart illustrating another example method that may limit reverse airflow in the event of the fan losing power.

### DETAILED DESCRIPTION

A computing device, such as a server of desktop, may be mounted in an enclosure, which is sometimes referred to as a “case.” To avoid excessive heat buildup, which can cause the computing device to malfunction, a plurality of fans may be attached to the enclosure.

It is a common occurrence that one of these fans may fail. In the event that one of the fans fails and other fans in the system continue to operate, the high air pressure created by the functioning fans may cause the failed fan to spin in reverse. In this case, the reverse-spinning fan causes air to be pulled out of the enclosure, which undermines the purpose of the fans, which is to push air into the enclosure.

Computing systems may be designed to continue functioning properly even in the event of a fan failure. However, system designs may not take into account the effect of the reverse airflow caused by the failed fan. The techniques described herein may reduce or eliminate the outflow of air caused by the failed fan by stopping rotation of the failed fan.

A fan may fail for many reasons. A fan printed circuit board (PCB) comprises a number of components that are prone to failure including MOSFETs (metal oxide semiconductor field effect transistors), one or more fuses, and a microcontroller. The techniques of this disclosure describe techniques for limiting reverse airflow caused by the failure of components of a fan in an enclosure.

More particularly, the techniques of this disclosure are directed toward techniques that incorporate a solenoid into the fan design. During normal fan operation, or at fan startup, the solenoid receives power and pulls the member out of contact with the rotor hub to allow the rotor hub to spin. However, if power is lost, the solenoid loses power and causes a member to come into contact with a hub of the rotor hub to stop the rotor hub from spinning. In some examples, the solenoid may be a linear actuator. In other examples, the solenoid may comprise a rotary solenoid.

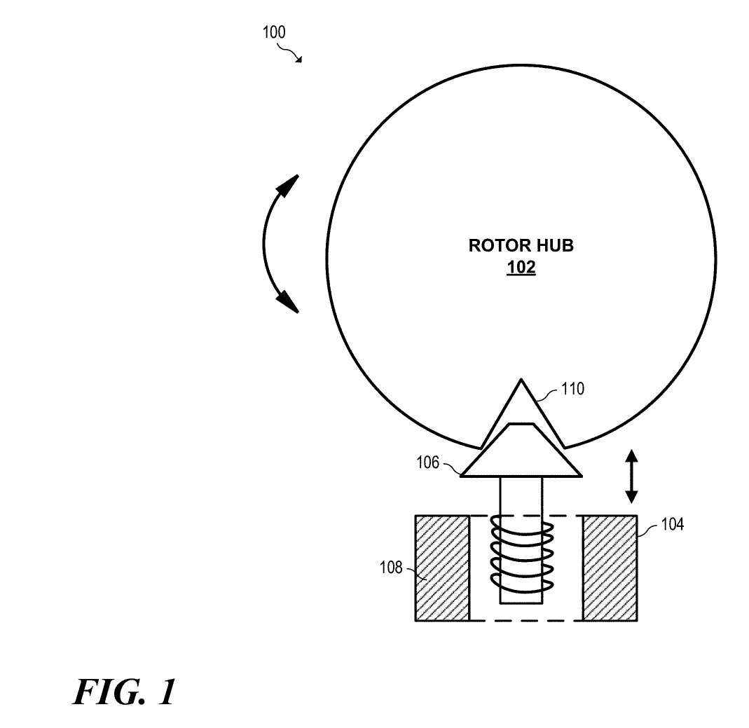

FIG. 1 is a conceptual diagram of a fan that may limit reverse airflow in the event of the fan losing power. Fan 100 is illustrated in FIG. 1. Fan 100 may be coupled to an enclosure of a computing device (e.g., a case chassis or the like). Fan 100 comprises a rotor hub 102, a linear solenoid 104, and a pin 106 disposed within a magnetic coil 108 of the solenoid.

Rotor hub 102 may comprise a circular member that is coupled to blades (not pictured) of fan 100. Rotor hub 102 may be coupled to a motor (not pictured). When the motor is supplied with power, the motor rotates rotor hub 102 and thereby also rotates the fan blades to cause airflow. However, as described herein, if a component of fan 100 fails, pressure within a chassis of a computing device may cause rotor hub 102 to spin reverse relative to the direction that is desirable for cooling a computing device.

Solenoid 104 comprises a magnetic coil 110 that may be toroidal in shape. Disposed within magnetic coil 110 is a spring that may actuate pin 106. When power is applied to solenoid 104, magnetic coil 108 creates a magnetic field that causes the spring disposed within the center of solenoid 104 to compress, thereby pulling pin 106 away from rotor hub 102. When pin 106 is pulled away from rotor hub 102, rotor hub 102 may spin freely (e.g. during normal operation).

When power is not applied to solenoid 104, the spring disposed in the center is not compressed and pin 106 contacts rotor hub 102 causing rotor hub 102 to stop spinning or to reduce spinning. In some examples, rotor hub 102 may comprise a detent 110. Detent 110 may comprise a cut-out within rotor hub 102. When solenoid 104 is not powered, pin 106 may catch on detent 110 to stop rotor hub 102 from spinning. In various examples, the end of pin 106 that catches on detent 110 may be roughly trapezoidal in shape to better fit within the similarly shaped detent 110. In other examples, detent 110 may be roughly triangular in shape or trapezoidal in shape.

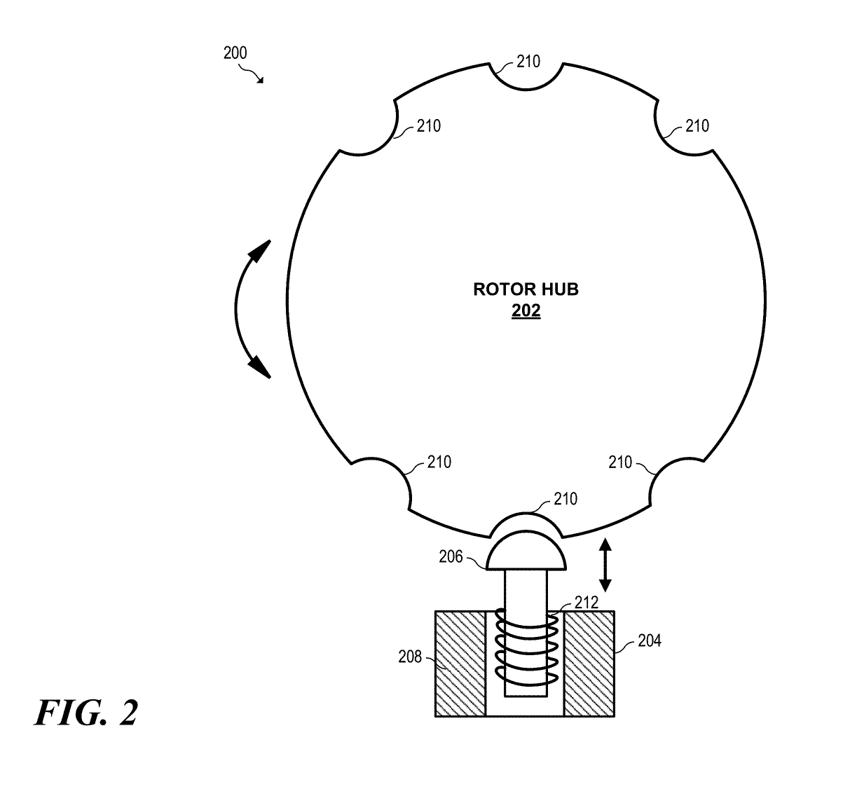

FIG. 2 is a conceptual diagram of an example fan that may limit reverse airflow in the event of a fan losing power. FIG. 2 illustrates a fan 200. Fan 200 comprises a rotor hub 202, a linear solenoid 204, and a pin 206. Pin 206 is disposed within a magnetic coil 208 of linear solenoid 204, and actuates via a spring 212 that surrounds pin 206. Spring 212 is also disposed within solenoid 204 and magnetic coil 208.

Rotor hub 202 may comprise an approximately circular member that is coupled to blades (not pictured) of fan 200. Rotor hub 202 may be coupled to a motor (not pictured). When the motor is supplied with power, the motor rotates rotor hub 202 and thereby also rotates the blades of fan 200. In the example of FIG. 2, rotor hub 202 comprises a plurality of detents 210. Each of detents 210 may be approximately semicircular in shape. Although six detents are illustrated in FIG. 2, rotor hub 202 may comprise more or fewer detents.

Solenoid 204 comprises a cylindrical magnetic coil 206. Disposed within magnetic coil 206 is a spring that may actuate pin 206. When power is applied to linear solenoid 204, magnetic coil 206 creates a magnetic field that causes the spring disposed within the center of solenoid 204 to compress, thereby pulling pin 206 away from rotor hub 202. When pin 206 is pulled away from rotor hub 202, rotor hub 202 may spin freely.

When power is not applied to solenoid 204, the spring disposed in the center is not compressed, and pin 206 contacts rotor hub 202 causing rotor hub 202 to stop spinning or to slow spinning. When pin 206 contact rotor hub 202, pin 206 may contact a plurality of detents 210 to stop or reduce rotor hub 202 from spinning. Detents 210 may be roughly semicircular in shape. Detents 210 may be shallower relative to detent 110 of FIG. 1. Because detents 210 are shallower, rotor hub 202 may continue to spin and pin 206 may catch on additional of detent(s) 210 before rotor hub 202 stops rotating.

Contacting a plurality of detents, rather than a single detent as described with respect to fan 100 (FIG. 1), slows the rotation rotor hub 202 more slowly relative to using a single detent to slow the rotor hub. Allowing the rotor hub to slow or stop more gradually may reduce the risk of damaging rotor hub 202, e.g. via excessive torque exerted by pin 206.

In this manner, fan 200 represents an example of a fan comprising a rotor hub 202 and a linear solenoid 204 comprising a magnetic coil 208 and a pin 206 disposed within the magnetic coil, and a spring 212 to actuate pin 206. Responsive to fan 200 losing power, solenoid 204 may cause pin 206 to contact rotor hub 202 to cause the rotor hub to stop spinning or reduce spinning.

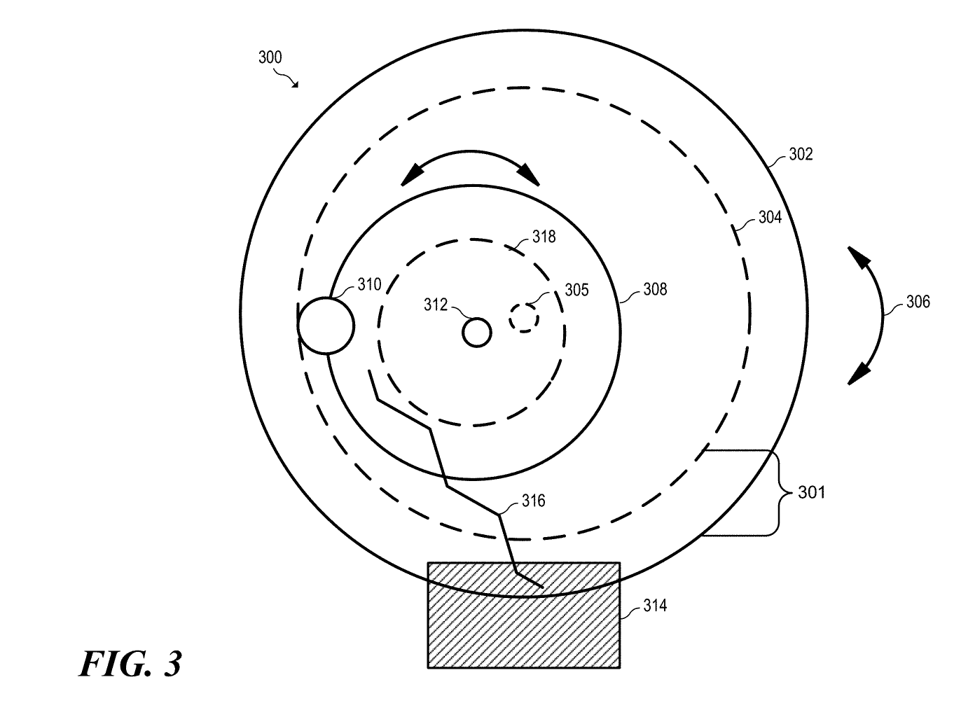

FIG. 3 is another conceptual diagram of an example fan that may limit reverse airflow in the event of the fan losing power. FIG. 3 illustrates a fan 300. FIG. 3 illustrates an overhead view of fan 300. Fan 300 comprises a rotor hub 301 comprising an outer ring 302, and an inner ring 304. Rotor hub 301 may rotate clockwise or counterclockwise about an axis 305. The potential directions of rotation of rotor hub 301 are illustrated by arrow 306.

Fan 300 also comprises a rotatable plate 308 that is coupled to a bi-stable rotary solenoid 318. Rotatable plate and rotary solenoid 318 are offset relative to the axis 305 of rotor hub 301. Rotatable plate 308 comprises a member 310, and rotates clockwise or counterclockwise about axis 312 responsive to the rotation of rotary solenoid 318.

Bi-stable rotary solenoid 318 is coupled to a power source. Bi-stable rotary solenoid 318 produces rotational motion in clockwise or counterclockwise directions every time the direction of current changes from positive to negative current or vice versa. In some examples, the position of bi-stable rotary solenoid 318 is maintained even when solenoid 318 is de-energized due to the force applied by spring 316. Spring 316 may be mounted to ground 314, which may comprise an enclosure of fan 300. In other examples, the position of bi-stable rotary solenoid 314 may be maintained by a permanent magnet disposed within rotary solenoid 318.

In the example of FIG. 3, rotatable plate 308 is illustrated in a position in which member 310 is in contact with inner ring 304 of rotor 301. When member 310 is in contact with inner ring 304, the friction between inner ring 304 and member 310 causes rotor 301 to reduce spinning or to stop spinning entirely.

Although rotatable plate 308 and bi-stable rotary solenoid 318 are illustrated as rotating in parallel with the axis of rotation of rotor hub 301 (indicated by arrow 306), rotatable plate 308 and bi-stable rotary solenoid 318 may be arranged in other configurations. As an example, bi-stable rotary solenoid 318 and rotatable plate 308 may rotate perpendicular to the axis of rotation of rotor hub 301.

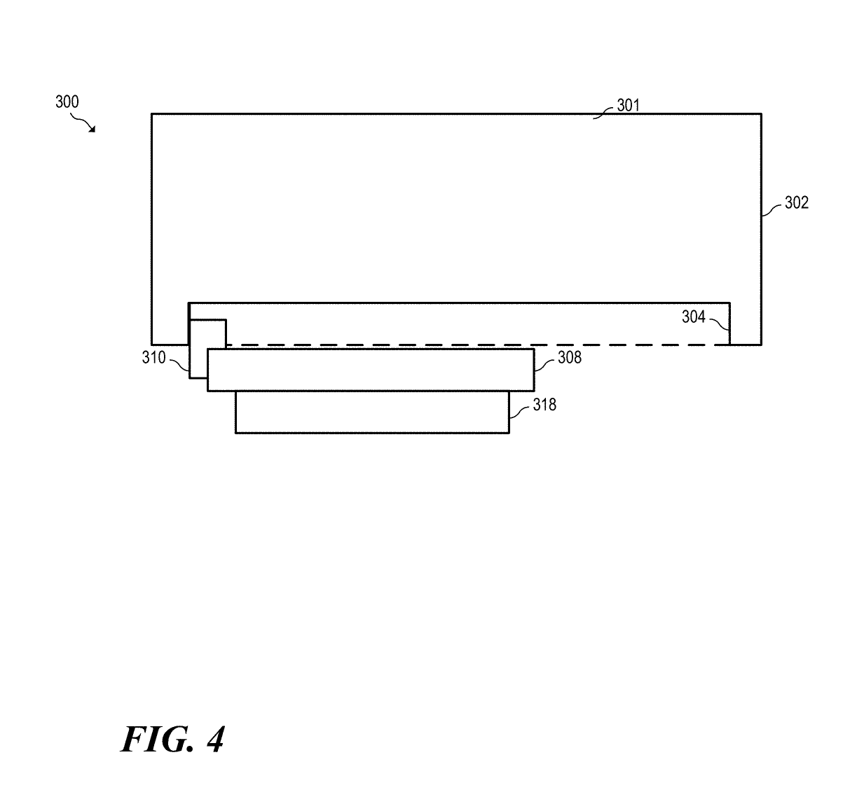

FIG. 4 illustrates another perspective of an example of a fan that may limit reverse airflow in the event of the fan losing power. FIG. 4 illustrates fan 300 (illustrated in FIG. 3) from a side perspective. Fan 300 comprises rotor hub 301, which comprises outer ring 302, and inner ring 304. Fan 300 also comprises rotatable plate 308, which comprises member 310. Rotatable plate 308 is coupled to bi-stable rotary solenoid 318.

In the example of FIG. 4, rotatable plate is in a braking position in which member 310 is in contact with inner ring 304. When member 310 is in contact with inner ring 304, the contact creates friction, which slows or stops the rotation of rotor hub 301.

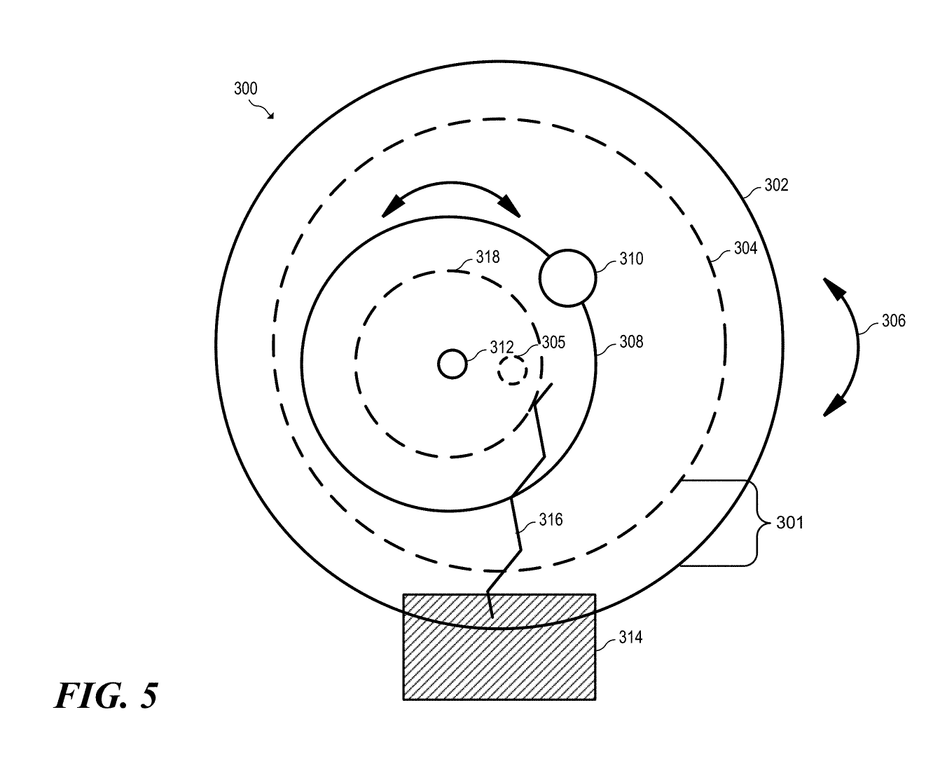

FIG. 5 is another conceptual diagram of an example fan that may limit reverse airflow in the event of the fan losing power. FIG. 5 illustrates an overhead view of fan 300 (also illustrated in FIG. 3). FIG. 5 illustrates another view of fan 300 in an unimpeded (i.e. non-braking position). Fan 300 comprises a rotor hub 301 comprising an outer ring 302, and an inner ring 304. Rotor hub 301 may rotate clockwise or counterclockwise about an axis 305. The direction of rotation of rotor hub 301 is illustrated by arrow 306.

Fan 300 comprises a rotatable plate 308. Rotatable plate is offset relative to the axis 305 of rotor hub 301. Rotatable plate 308 comprises a member 310, and rotates clockwise or counterclockwise about axis 312. Fan 300 also comprises a bi-stable rotary solenoid 318. The position of bi-stable rotary solenoid 318 is maintained even when solenoid 318 is de-energized due to the force applied by spring 316 or by a permanent magnet of solenoid 318.

In the example of FIG. 5, rotatable plate 308 is illustrated in a position in which member 310 is not in contact with inner ring 304 of rotor 301. When member 310 is not in contact with inner ring 304, there is no friction between inner ring 304 and member 310. Therefore, rotor 301 may spin freely when rotatable plate 308 is in the position illustrated in FIG. 5.

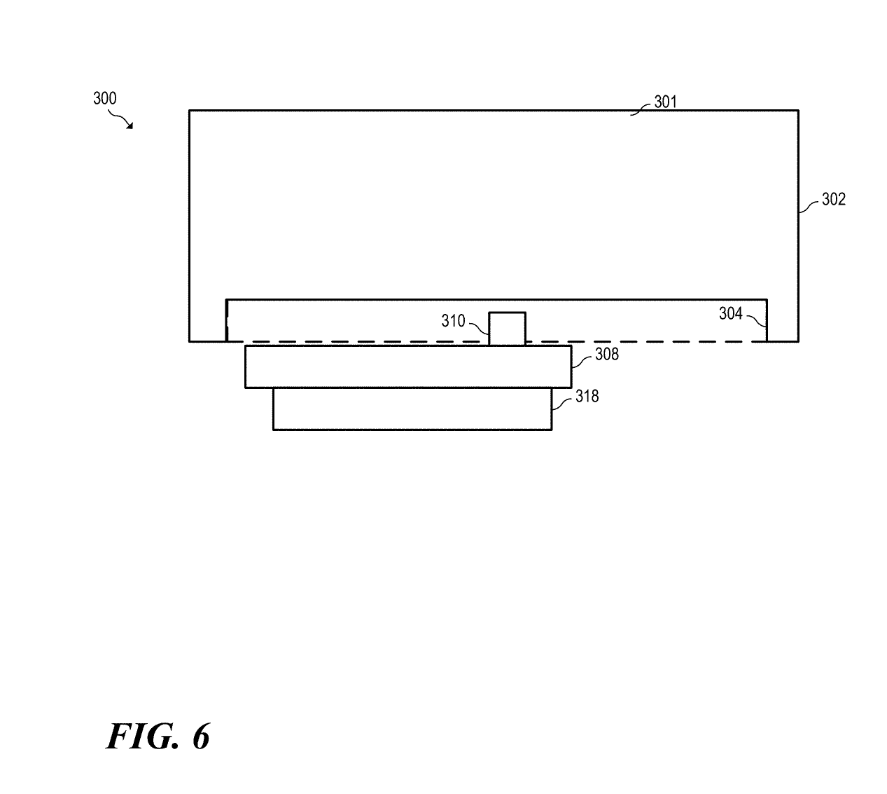

FIG. 6 illustrates another perspective of an example of a fan that may limit reverse airflow in the event of the fan losing power. FIG. 6 illustrates fan 300 (illustrated in FIG. 3) from a side perspective. In FIG. 6, Rotatable member 308 is rotated in a position where member 310 is not in contact with inner ring 304. When member 310 is not in contact with inner ring 304, there is no friction between member 310 and inner ring 304 so rotor hub 301 may rotate freely. During normal operation, rotatable plate 308 may be in the unimpeded position illustrated in FIG. 6.

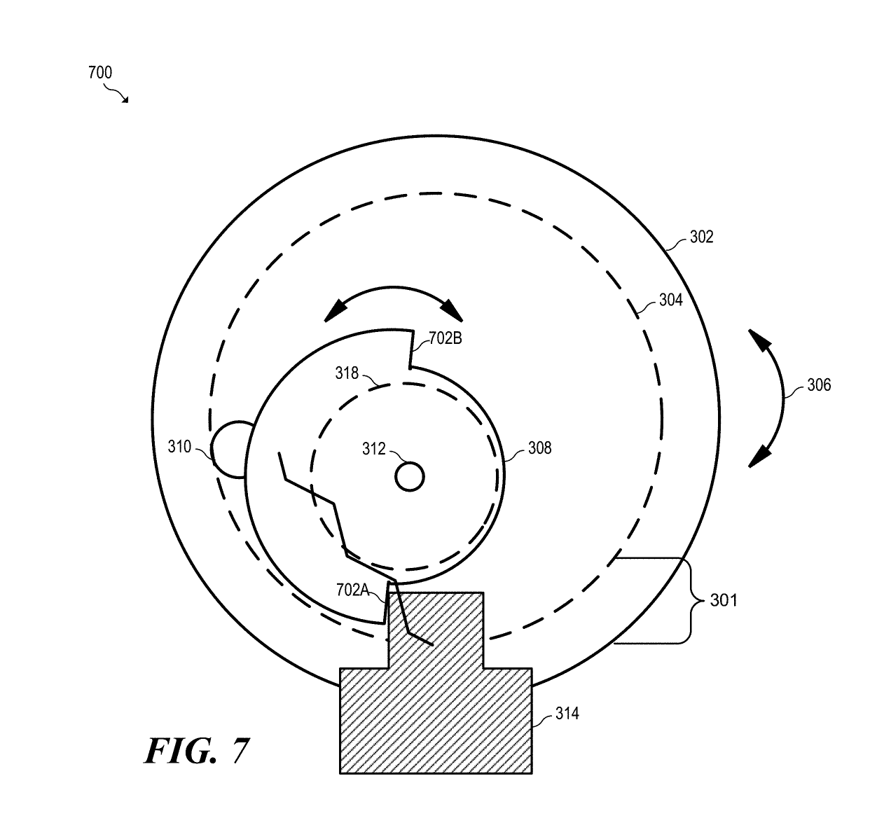

FIG. 7 illustrates another example of a fan that may limit reverse airflow in the event of the fan losing power. FIG. 7 illustrates a fan 700. Fan 700 is similar to Fan 300 (FIG. 3). Fan 700 includes a rotor hub 301 comprising an outer ring 302, and an inner ring 304. Inner ring 304 may comprise an inner face. Fan 700 also comprises a rotatable plate 308 comprising a member 310. In the example of FIG. 7, member 310 is in contact with inner ring 304, thereby creating friction to slow or stop rotor 301.

In the example of FIG. 7, rotatable plate 308 comprises catch positions 702A and 702B (catch positions 702). Catch positions 702 are disposed on the perimeter of rotatable plate 308. Catch positions 702 contact fan housing 314 to stop over-rotation of rotatable plate 308. In the example of FIG. 7, catch position 702A is in contact with fan housing 314 to stop further counterclockwise rotation of rotatable plate 308.

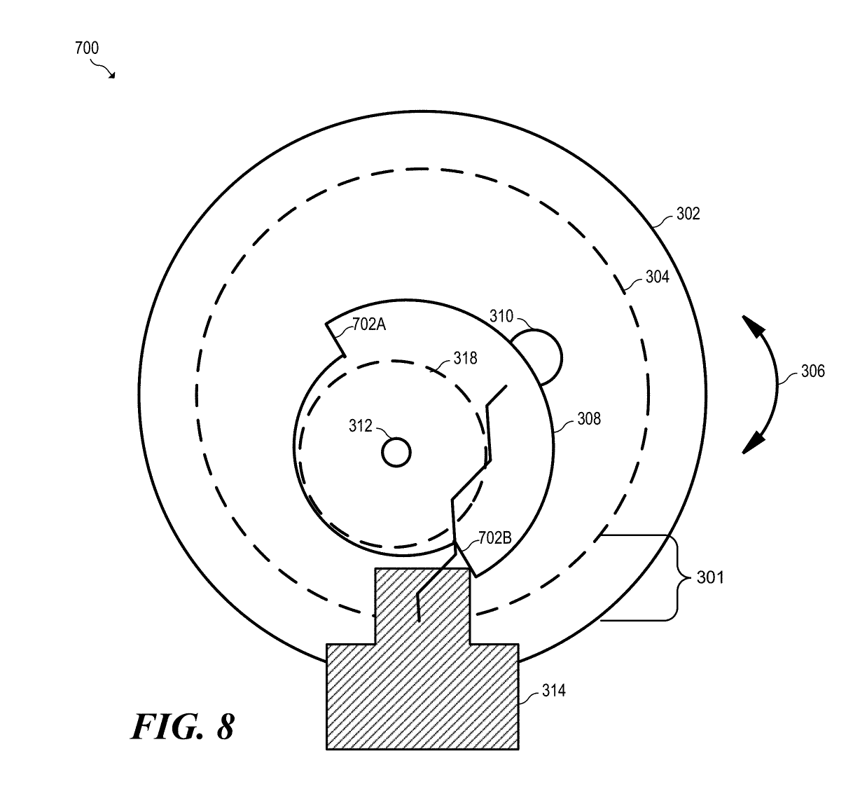

FIG. 8 illustrates another example of a fan that may limit reverse airflow in the event of the fan losing power. FIG. 8 illustrates fan 700 with rotatable plate 308 in a different position. Fan 700 is similar to Fan 300 (FIG. 3). Fan 700 includes a rotor hub 301 comprising an outer ring 302, and an inner ring 304. Fan 700 also comprises a rotatable plate 308 comprising a member 310. In the example of FIG. 7, member 310 is not in contact with the inner face of inner ring 304, so no friction to slow or stop rotor 301 is created by member 310.

As in the example of FIG. 7, rotatable plate 308 comprises catch positions 702A and 702B (catch positions 702). Catch positions 702 are disposed on the perimeter of rotatable plate 308. Catch positions 702 contact fan housing 314 to stop over-rotation of rotatable plate 308. In the example of FIG. 8, catch position 702B is in contact with fan housing 314 to stop further clockwise rotation of rotatable plate 308.

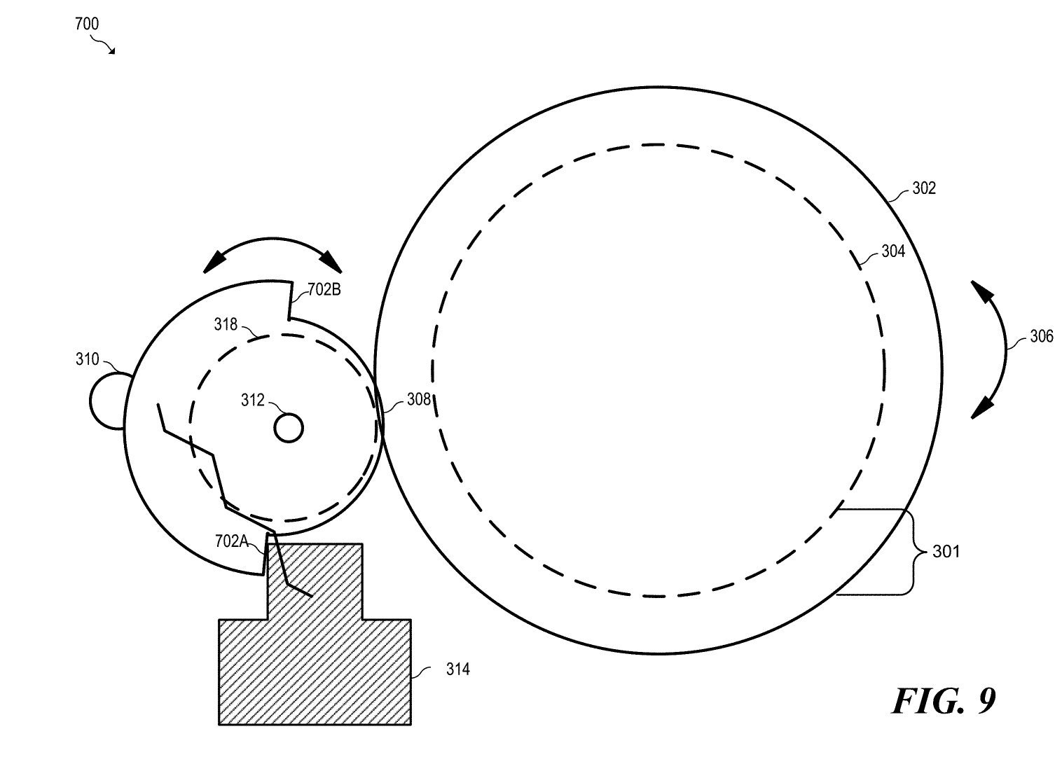

FIG. 9 illustrates another example of a fan that may limit reverse airflow in the event of the fan losing power. FIG. 9 illustrates a fan 900. Fan 900 is similar to Fan 300 (FIG. 3) and fan 700 (FIG. 7). Fan 900 includes a rotor hub 301 comprising an outer ring 302 comprising an outer face, and an inner ring 304 comprising an inner face. Fan 900 also comprises a rotatable plate 308 comprising a member 310. In the example of FIG. 9, rotatable plate 308 is positioned outside of rotor hub 301. Member 310 may be rotated to contact an outer face of outer ring 302. In the example of FIG. 9, member 310 is out of contact with an outer face of outer ring 302 rotor hub 301, therefore no friction is created to slow or stop rotor 301.

In the example of FIG. 9, rotatable plate 308 comprises catch positions 702A and 702B (catch positions 702). Catch positions 702 are disposed on the perimeter of rotatable plate 308. Catch positions 702 contact fan housing 314 to stop over-rotation of rotatable plate 308. In the example of FIG. 7, catch position 702A is in contact with fan housing 314 to stop further counterclockwise rotation of rotatable plate 308.

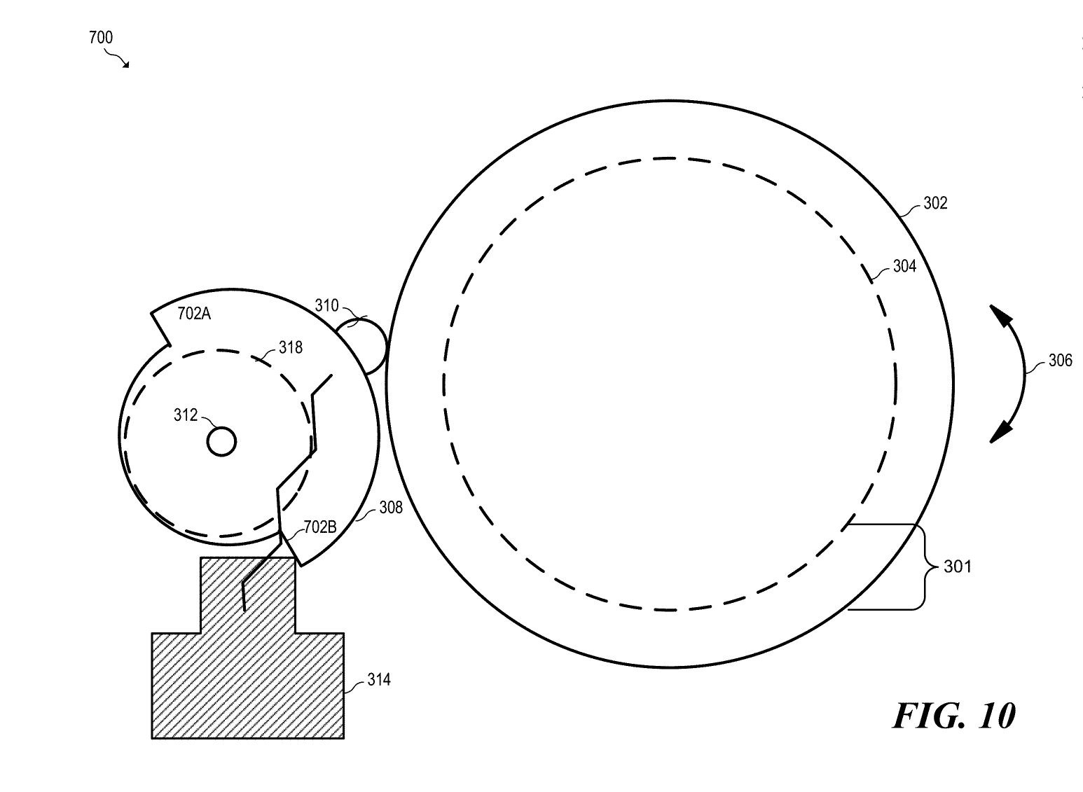

FIG. 10 illustrates another example of a fan that may limit reverse airflow in the event of the fan losing power. FIG. 10 illustrates fan 900 with rotatable plate 308 in a different position relative to FIG. 9. Fan 900 is similar to Fan 300 (FIG. 3). Fan 900 includes a rotor hub 301 comprising an outer ring 302, and an inner ring 304. Fan 900 also comprises a rotatable plate 308 comprising a member 310. Member 310 may be rotated to contact an outer face of outer ring 302. In the example of FIG. 10, member 310 is in contact with an outer face of outer ring 302 of rotor hub 301, thereby creating friction to slow or stop rotor 301.

As in the example of FIGS. 7, 8, and 9, in FIG. 10, rotatable plate 308 comprises catch positions 702A and 702B (catch positions 702). Catch positions 702 are disposed on the perimeter of rotatable plate 308. Catch positions 702 contact fan housing 314 to stop over-rotation of rotatable plate 308. In the example of FIG. 10, catch position 702B is in contact with fan housing 314 to stop further clockwise rotation of rotatable plate 308.

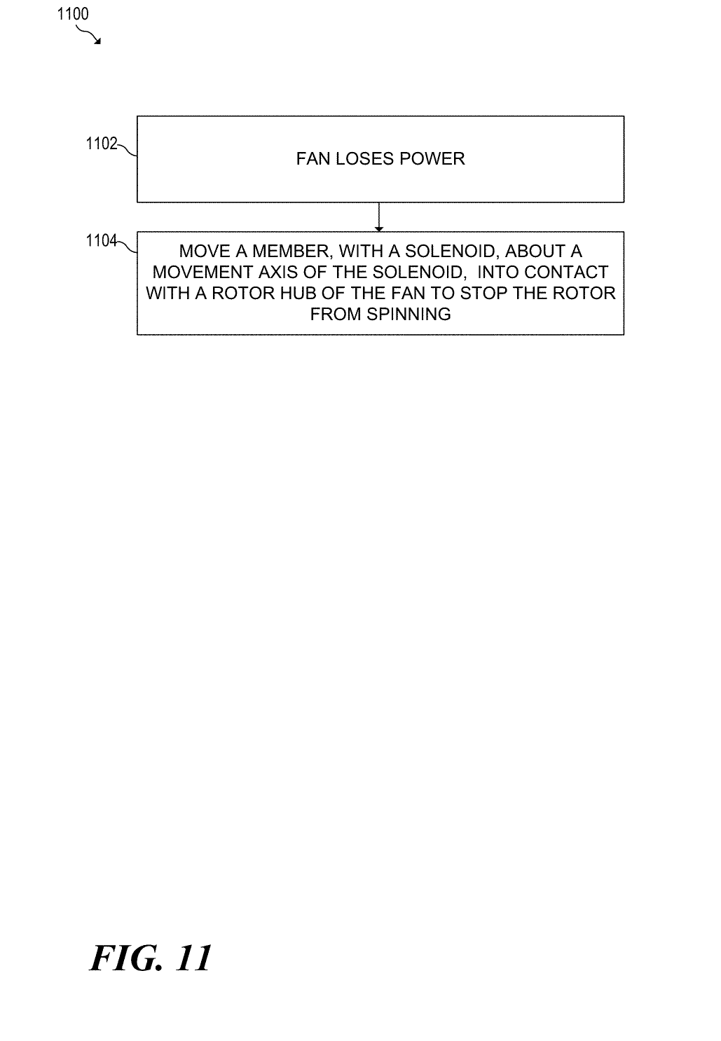

FIG. 11 is a flowchart of an example method that may limit reverse airflow in the event of a fan losing power. FIG. 11 illustrates method 1100. Method 1100 may be described below as being executed or performed by a device, for example, fan 100 (FIG. 1), fan 200 (FIG. 2), fan 300 (FIG. 3-FIG. 6), or fan 700 (FIGS. 7, 11).

Other suitable systems and/or devices may be used as well. In alternate examples of the present disclosure, one or more blocks of method 1100 may be executed substantially concurrently or in a different order than shown in FIG. 11. In alternate examples of the present disclosure, method 1100 may include more or fewer blocks than are shown in FIG. 11. In some examples, one or more of the blocks of method 1100 may, at certain times, be ongoing and/or may repeat.

In various examples, method 1100 may start at block 1102 at which the fan (e.g. fan 100, fan 700, or the like) may lose power. At block 1104, responsive to the fan losing power, a solenoid (e.g. solenoid 104, solenoid 204, or solenoid 318) may move a member (e.g. member 106, member 206, or member 310) into contact with a rotor hub (e.g. rotor hub 102, rotor hub 202, or rotor hub 301). Moving the member into contact with the rotor hub may cause the rotor hub to stop spinning.

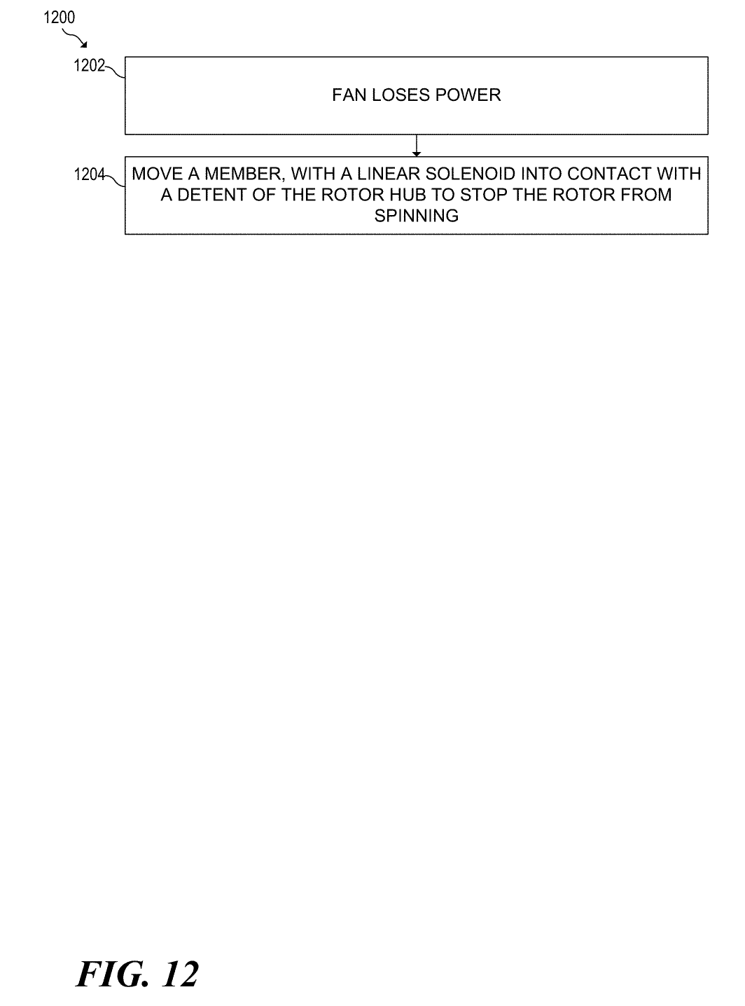

FIG. 12 is a flowchart of an example method that may limit reverse airflow in the event of a fan losing power. FIG. 12 illustrates method 1200. Method 1200 may be described below as being executed or performed by a device, for example, fan 120 (FIG. 1).

Other suitable systems and/or devices may be used as well. In alternate examples of the present disclosure, one or more blocks of method 1200 may be executed substantially concurrently or in a different order than shown in FIG. 12. In alternate examples of the present disclosure, method 1200 may include more or fewer blocks than are shown in FIG. 12. In some examples, one or more of the blocks of method 1200 may, at certain times, be ongoing and/or may repeat.

In various examples, method 1200 may start at block 1202 at which the fan (e.g. fan 120) may lose power. At block 1204, responsive to the fan losing power, a linear solenoid (e.g. linear solenoid 124) may move a member (e.g. member 126) into contact with a detent (e.g. detent 112) of a rotor hub (e.g. rotor hub 122). Moving the member into contact with detent the rotor hub may cause the rotor hub to stop spinning.

In various examples, the solenoid may comprise a linear solenoid, e.g. solenoid 124 or solenoid 204. In some examples, the linear solenoid may move the pin into contact with a single detent of the rotor hub (e.g. detent 112) to stop the rotor hub from spinning.

FIG. 13 is a flowchart of an example method that may limit reverse airflow in the event of a fan losing power. FIG. 13 illustrates method 1300. Method 1300 may be described below as being executed or performed by a device, for example, fan 200 (FIG. 2).

Other suitable systems and/or devices may be used as well. In alternate examples of the present disclosure, one or more blocks of method 1300 may be executed substantially concurrently or in a different order than shown in FIG. 13. In alternate examples of the present disclosure, method 1300 may include more or fewer blocks than are shown in FIG. 13. In some examples, one or more of the blocks of method 1300 may, at certain times, be ongoing and/or may repeat.

In various examples, method 1300 may start at block 1302 at which the fan (e.g. fan 200) may lose power. Fan 200 may comprise rotor hub 202, which may comprise a plurality of detents. At block 1304, responsive to the fan losing power, a linear solenoid (e.g. linear solenoid 204) may move a member (e.g. member 206) into contact with a first detent (e.g. a first one of detents 210) of a rotor hub (e.g. rotor hub 202).

At block 1306, the linear solenoid may move the member into contact with at least a second one of the detents, e.g. at least a second one of detents 210 to stop the rotor hub from spinning.

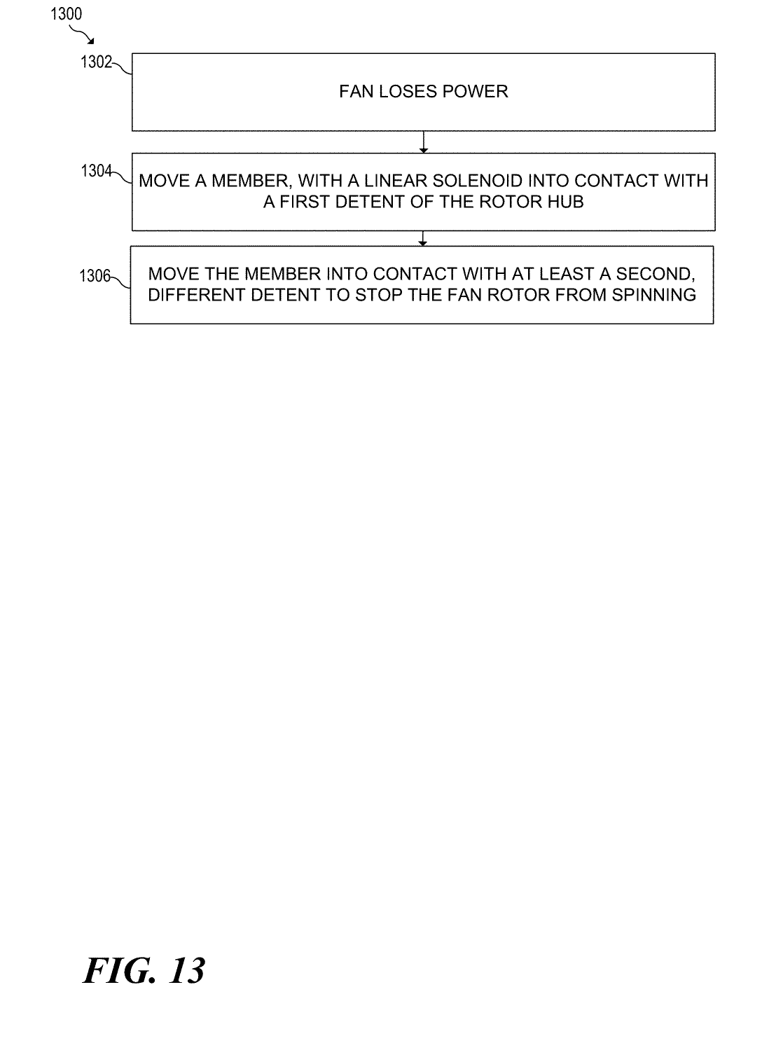

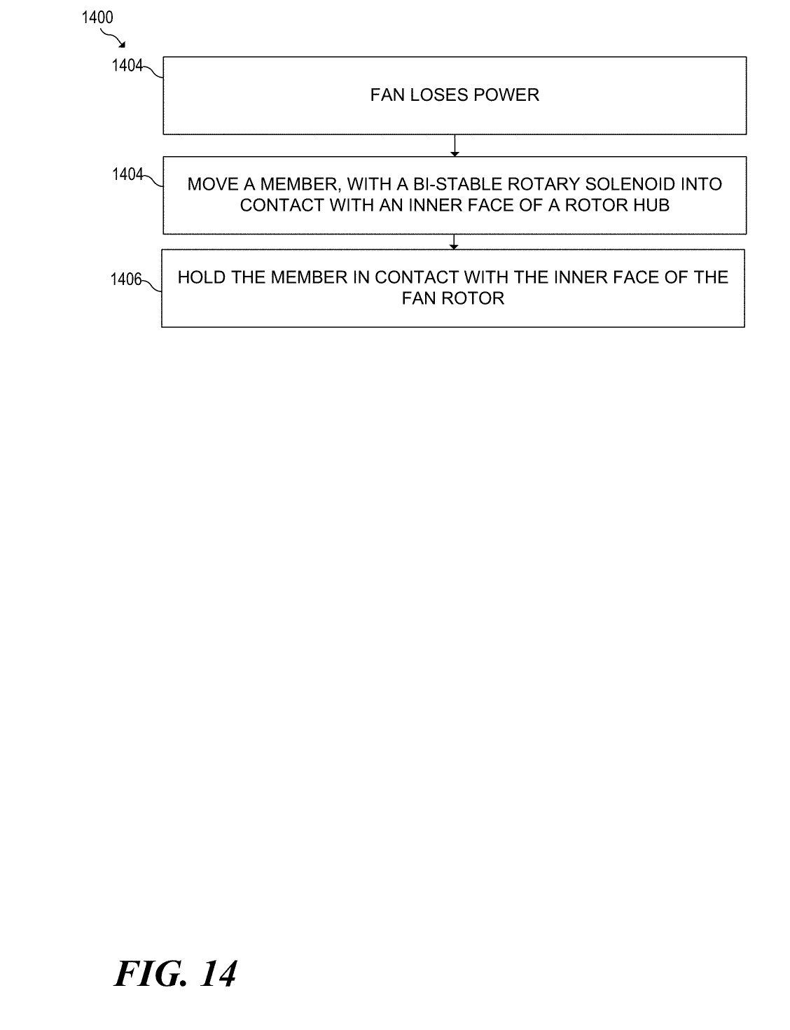

FIG. 14 is a flowchart of an example method that may limit reverse airflow in the event of a fan losing power. FIG. 14 illustrates method 1400. Method 1400 may be described below as being executed or performed by a device, for example, fan 300 (FIG. 3).

Other suitable systems and/or devices may be used as well. In alternate examples of the present disclosure, one or more blocks of method 1400 may be executed substantially concurrently or in a different order than shown in FIG. 14. In alternate examples of the present disclosure, method 1400 may include more or fewer blocks than are shown in FIG. 14. In some examples, one or more of the blocks of method 1400 may, at certain times, be ongoing and/or may repeat.

In various examples, method 1400 may start at block 1402 at which the fan (e.g. fan 300) may lose power. At block 1404, responsive to the fan losing power, a bi-stable rotary solenoid (e.g. bi-stable rotary solenoid 318) may move a member (e.g. member 310) into contact with a face (e.g. inner face 304) of a rotor hub (e.g. rotor hub 301). In some examples, member 310 may contact an outer or other face of rotor hub 301. Moving the member into contact with the face of the rotor hub may cause the rotor hub to stop spinning. In various examples, a spring 316 may be coupled to a housing of the fan (e.g. housing 314). The spring may hold the member in contact or out of contact with the face of the rotor hub.

1. A method comprising:
responsive to a fan losing power,
moving a member, with a solenoid, about a movement axis of the solenoid, into contact with a rotor hub of the fan,
wherein moving the member into contact with the rotor hub causes the rotor hub to stop spinning.

2. The method of claim 1, wherein the solenoid comprises a linear solenoid, and wherein the member comprises a pin disposed within a magnetic coil of the solenoid.

3. The method of claim 2, wherein rotor hub comprises a single detent, the method comprising:
moving, with the linear solenoid, the pin into contact with the detent of the rotor hub to stop the rotor hub from spinning.

4. The method of claim 2, wherein the rotor hub comprises a plurality of detents, the method comprising:
moving the pin into contact with the rotor hub comprises moving the pin into contact with a first one of the detents; and
moving the pin into contact with at least a second one of the detents to stop the rotor hub from spinning.

5. The method of claim 1, wherein the solenoid comprises a bi-stable rotary solenoid,
wherein moving the member into contact with the rotor hub comprises moving the member into contact with a face of the rotor hub.

6. The method of claim 5, comprising:
holding, with a spring coupled to a housing of the fan, the member in contact or out of contact with the face of the rotor hub.

7. A device comprising a fan, the fan comprising:
a rotor hub; and
a linear solenoid comprising:
a magnetic coil;
a pin; and
a spring surrounding the pin to bias the pin;
responsive to the fan losing power, the solenoid to:
cause the pin to contact the rotor hub to cause the rotor hub to stop spinning.

8. The device of claim 7, wherein the rotor hub comprises a detent.

9. The device of claim 8, the solenoid to:
cause the pin to contact the detent to stop the rotor hub from spinning.

10. The device of claim 7, wherein the rotor hub comprises a plurality of detents, the solenoid to:
cause the pin to contact a first one of the detents; and
contact at least a second, different one of the detects to stop the rotor hub from spinning.

11. The device of claim 7, the solenoid to: receive current from a power source; and
responsive to solenoid receiving the current:
move the pin out of contact from the rotor hub.

12. The device of claim 7, wherein a direction of actuation of the solenoid is orthogonal to a rotational axis of the rotor hub.

13. The device of claim 7, wherein the direction of actuation of the solenoid is parallel to a rotational axis of the rotor hub.

14. A device comprising a fan, the fan comprising:
a rotor hub; and
a bi-stable rotary solenoid comprising:
a magnetic coil; and
a rotatable plate coupled to the bi-stable rotary solenoid, the rotatable plate comprising a member;
responsive to the fan losing power, the solenoid to:
rotate the plate to cause the member to contact the rotor hub to cause the rotor hub to stop spinning.

15. The device of claim 14, wherein responsive to receiving the power, the solenoid to cause a member of the plate to contact an inner face of the rotor hub.

16. The device of claim 14, wherein a rotational axis of the rotary solenoid is parallel with a rotational axis of the rotor hub.

17. The device of claim 14, wherein the rotatable plate comprises stops disposed on a perimeter of the plate to stop the plate from rotating.

18. The device of claim 14, wherein the bi-stable rotary solenoid comprises a spring, the spring to hold the rotatable plate in contact with rotor hub or out of contact with the rotor hub.

19. The device of claim 14, wherein the bi-stable rotary solenoid is offset relative to a center of the rotor hub.
